(19) United States
(12) Patent Application Publication
(10) Pub. No.: US 2019/0236460 A1
(43) Pub. Date: Aug. 1, 2019

(54) MACHINE LEARNT MATCH RULES

(71) Applicant: salesforce.com, inc., San Francisco, CA (US)

(72) Inventors: Arun Kumar Jagota, Sunnyvale, CA (US); Dmytro Kudriavtsev, Belmont, CA (US); Rakesh Ganapathi Karanth, San Mateo, CA (US)

(21) Appl. No.: 15/882,134

(22) Filed: Jan. 29, 2018

(51) Int. Cl. G06N 5/02; G06N 99/00; G06F 17/30

(52) U.S. Cl. CPC G06N 5/025; G06F 17/30864; G06N 99/005

(57) ABSTRACT

A training dataset having training instances is determined. Each training instance comprises first and second records and a second record and a label indicate whether there is a match between the first and second records. A matching score vector is determined for each such training instance, and comprises components storing match scores for extracted features from field values in the first and second records. Based on matching score vectors and a match objective function, match score thresholds are determined for the extracted features. Match rule(s) each of which comprises predicate(s) are generated. Each predicate makes a predication on whether two records match by comparing a match score derived from the two records against a match score threshold.

### TECHNICAL FIELD

The present invention relates generally to supervised machine learning, and in particular, to generating and applying machine learnt match rules.

### BACKGROUND

A database system that supports massive volumes of transactions and interactions on a daily or weekly basis may introduce numerous semantically duplicate records. These records may come from wide varieties of data sources, systems/devices, processes, manual inputs, data input pathways, etc. While records may look different in specific data field values, the records may actually refer to much less numerous common entities.

Unrecognized or misidentified common entities can lead to wastes in computing resources, inefficiencies in computing operations, and likelihoods of operational errors. For example, different people searching for the same entity may get different versions of it, as these versions may have somewhat differing information, e.g., for contact address or phone. Where multiple records actually refer to a common entity, a system that fails to recognize this may use extra database and computing resources to store and manipulate these records, perform additional data retrievals and data processing with respect to these records, fail to apply correct operations consistently across all instances of the common entity, and even apply wrong operations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1A illustrates an example overall machine learning workflow 100 for generating and applying matching rules in a computing system; FIG. 1B illustrates a part of an example machine learning workflow for extracting features from training instances in a training dataset and generating predicates in match rules based on the extracted features; FIG. 1C illustrates a part of an example machine learning workflow for applying match rules; FIG. 1D illustrates an example process flow for viewing and editing match rules;

FIG. 2A and FIG. 2B illustrate two example training instances;

FIG. 3 illustrates an example process flow of deriving match rules based on the match score thresholds for extracted features and respective errors for the match score thresholds;

FIG. 4 illustrates an example process flow; and

FIG. 5 illustrates an example hardware platform on which a computer or a computing device as described herein may be implemented.

### DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:
1.0. General Overview
2.0. Functional Overview
   2.1. Generating Predicates in Match Rules
   2.2. Applying Match Rules
   2.3. Inspecting and Editing Match Rules
3.0. Example Embodiments
4.0 Implementation Mechanism—Hardware Overview
5.0. Extensions and Alternatives

### 1.0 General Overview

This overview presents a basic description of some aspects of an embodiment of the present invention. It should be noted that this overview is not an extensive or exhaustive summary of aspects of the embodiment. Moreover, it should be noted that this overview is not intended to be understood as identifying any particularly significant aspects or elements of the embodiment, nor as delineating any scope of the embodiment in particular, nor the invention in general. This overview merely presents some concepts that relate to the example embodiment in a condensed and simplified format, and should be understood as merely a conceptual prelude to a more detailed description of example embodiments that follows below.

A machine learning workflow as described herein can be used to generate match rules from a training dataset comprising training instances. Each of the training instances in the training dataset comprises a pair of training records representing underlying entities such as companies, products, events, and so forth, and a label indicating whether there is a match or mismatch between the pair of training records.

The match rules can be used to determine whether two non-training records, even if different in their respective data field values, are to be predicted as a match or a non-match. As used herein, records that are to be predicted as matches or non-matches may refer to any of: database records, database views, query results, filed based records, and so forth.

Techniques as described herein can be used to provide a number of benefits, including but not necessarily limited to: (a) automatic entity matching and recognition among a massive volume of data in the computing system; (b) data consistency across over a set of database tables across a plurality of instances of one or more datacenters in the computing system; (c) complete white-box information about a match or non-match decision made with any match rule in the plurality of sets of match rules in terms of specific predicates used in the match rule, specific feature extraction methods used in the specific predicates of the match rule, specific similarity measure used to compute match scores for the specific predicates of the match rule, or specific match score threshold used to compare computed match scores for the specific predicates of the match rule; and so forth.

In some operational scenarios, match rules as described herein can be used to identify database records—e.g., in databases of a complicated computing system such as a cloud-based computing system that supports massive volumes of concurrent and sequential transactions and interactions—are to be considered as matches. The match rules may be used to improve data consistency in the databases. An operation, an action, a constraint, a trigger, an event, and so forth, that is applicable to one of the matched records can be equally or similarly applied to the rest of the matched records. Incomplete data field values of some of the records may be completed from those complete data field values of some others of the records that match to the former records.

In some operational scenarios, match rules as described herein can be used to deduplicate, or remove duplicate records from, large numbers (e.g., hundreds of thousands, millions, billions, etc.) of records for a large number (e.g., hundreds of thousands, millions, etc.) of tenants/organizations hosted in a multi-tenant computing system. The records to be de-duplicated may be in a wide variety of data stores, databases, data tables, data sets, etc., including but not limited to those related to any of: Contacts, Leads, Accounts, Company locations, shipping addresses, events, and so forth.

On one hand, match rules generated based on black-box machine learning may be neither editable nor informative to users/customers. On the other hand, defining, refining (e.g., manually tweaking existing match rules to accommodate previously unforeseen scenarios, etc.) and using manual match rules may be time consuming, laborious and error prone. It may be impossible for human experts to discover effective match rules in light of large numbers of variations and subtle differences that may exist in various data fields of numerous records.

In contrast, machine learning techniques as described herein can be used to recognize and discover most effective features among variations and subtle differences in numerous records automatically and efficiently. Match rules comprising prediction predicates built on the most discriminating features can be constructed automatically with relatively high accuracy in match or non-match predictions.

These techniques can apply a variety of feature extraction methods, match score or similarity measures, efficient recursive and/or iterative processes, match score optimization methods, and so forth, to discover and extract the most discriminating features from data field values of records in training instances. The most discriminating features—which may be impossible for human experts to discover—can be readily discovered with these techniques and efficiently used to produce match rules in relatively short time periods. Additionally, the match rules can be adapted automatically to previously unforeseen scenarios by enhancing the training sets and re-training. These match rules in turn can be applied to deduplicate numerous (non-training) records daily and weekly.

These techniques can also efficiently incorporate continuous machine learning, manual input, background knowledge, domain knowledge, human expert input, etc. Cross-discipline domain knowledge may be incorporated to set values of labels in the training instances to identify records representing underlying company entities as matches or non-matches. Examples of the matches and non-matches in the training instances can be provided based at least in part on the cross-discipline domain knowledge.

Given a training set comprising the training instances, supervised learning algorithms/methods can be implemented to automatically extract features from field values in data fields of records in the training instances. From the extracted features, predicate features that best predict matches can be automatically identified. These predicate features may be combined with optimal thresholds to generate predicates for constructing match rules. A match rule may comprise a set of (e.g., conjunctive, etc.) predicates. In the case of conjunctive predicates, a match predicted by the match rule means that each and every predicate in the match rule predicts a match. Different match rules (e.g., any two of them, etc.) may be applied disjunctively. In some operational scenarios, a match predicted by any of the match rules may be considered as a match as a whole.

Match rules can be generated in a white-box model under techniques as described herein, in order to provide transparency and editability of the match rules. Components (e.g., predicates, etc.), parameters (e.g., match scores, similarity measures, etc.), thresholds (e.g., match score thresholds, etc.), and so forth, in the match rules as automatically generated through supervised machine learning can be reviewed, readily understood, and manually edited by users/customers/professionals. The match rules can be defined in a data driven manner. For example, the match rules may be externalized or represented in JSON files, displayed to a user through a user interface, edited by a user, and saved back to the JSON files, etc. Thus, the match rules and components used to define the match rules can be reviewed, updated and fine-tuned to a specific user or a specific user organization through user input. Users (e.g., administrators, privileged users, designated users, etc.) can inspect and blends results of automatic machine learning and user/expert input into the match rules. Example match rule editing operations based on user/expert input may include, but are not necessarily limited to: any one of: modifying predicate composition of the match rule, modifying a match score threshold in a predicate in the match rule, modifying a feature extraction method for extracting a feature in a predicate in the match rule, modifying a similarity function used to determine match scores for a feature in a predicate in the match rule, etc. Thus, behaviors of the match rules initially automatically generated in the white-box model supported under techniques as described herein can be readily modified, adapted, or enhanced based on user/expert input.

In addition, a match or non-match decision made by any match rule in the match rules can be readily conveyed to and reviewed by a user. Through a user interface, any of the match rules can be inspected, edited, and/or tweaked. The reasons why a match or non-match is decided by a match rule or any of the predictions by individual predicates in a match rule are readily reviewable from the features extracted from the field values. Because the match rules can be readily understood by users, clients who are impacted by any decisions made by the match rules can be informed of specific reasons why the decisions are made. Explanation can be added as a part of the match rules based on real-world applications of the match rules.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2.0 Functional Overview

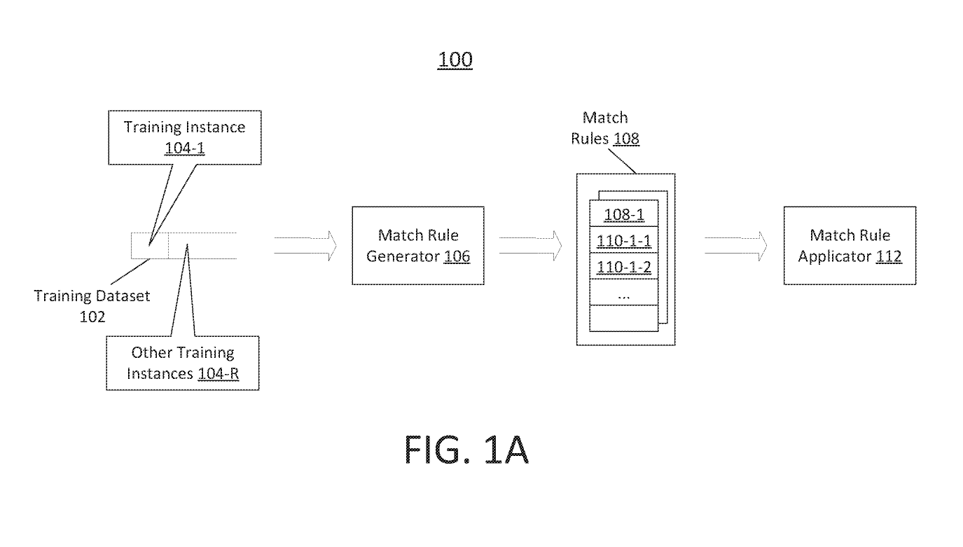

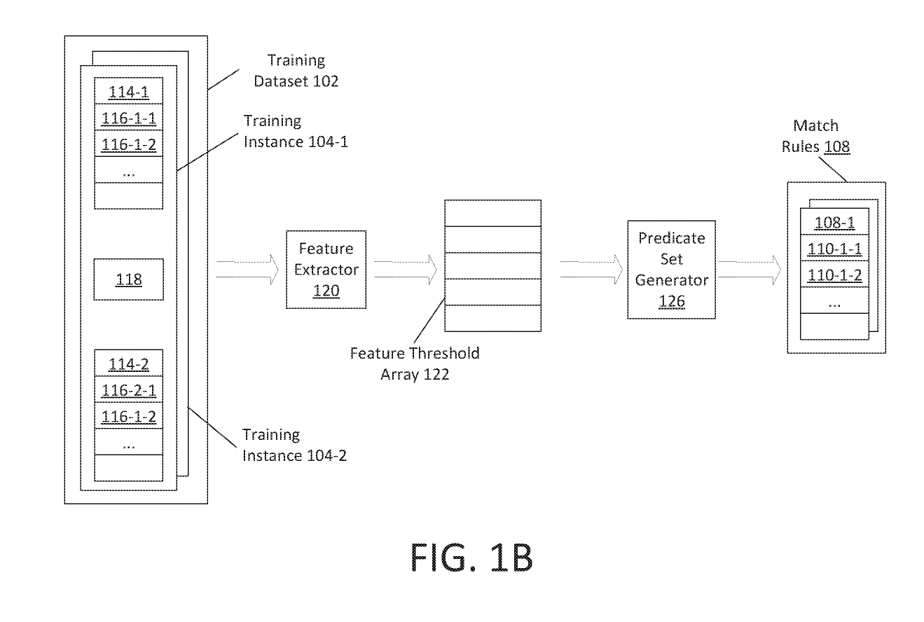

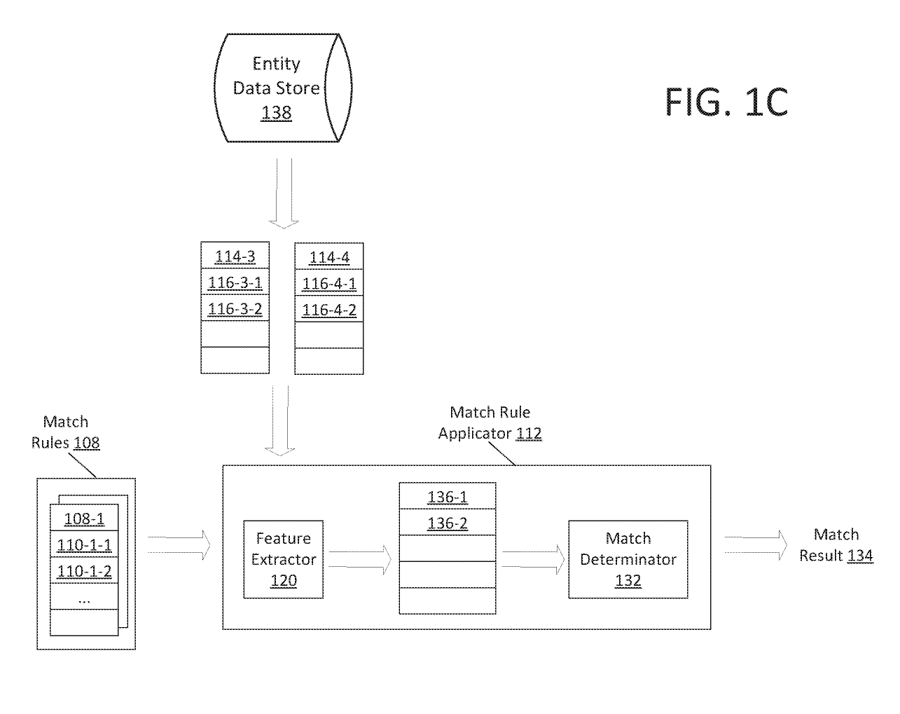

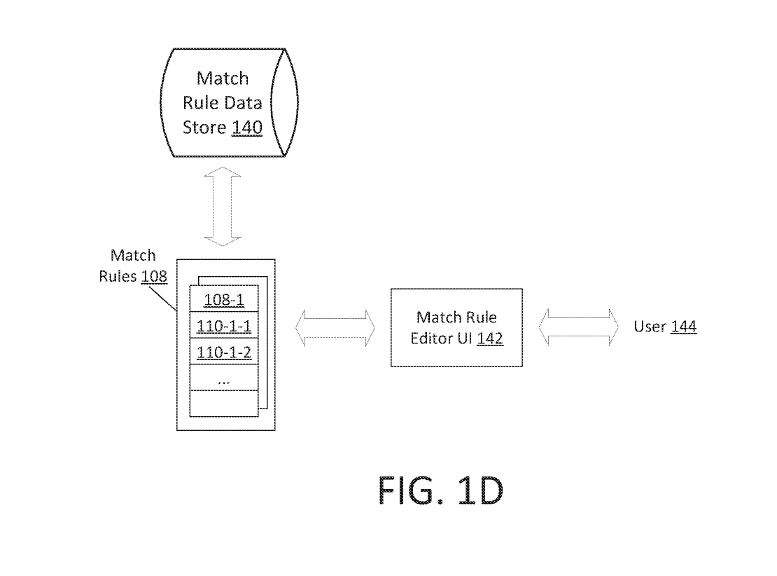

FIG. 1A illustrates an example overall machine learning workflow 100 for generating and applying matching rules in a computing system. Example computing systems that implement the machine learning workflow (100) may include, but are not necessarily limited to: any of: a large-scale cloud-based computing system, a system with multiple datacenters, multitenant data service systems, web-based systems, systems that support massive volumes of concurrent and/or sequential transactions and interactions, database systems, and so forth. In some embodiments, the machine learning workflow (100) may be extended and applied to multiple tenants in a multi-tenant database system with individual training sets, individual matching rules, individually reviewed and edited matching rules.

In some embodiments, the machine learning workflow (100) implements a supervised learning algorithm that takes a training dataset 102 as input. The training dataset (102) comprises a plurality of training instances 104-1, 104-R, etc. A training instance (e.g., 104-1, 104-R, etc.) in the training dataset (102) may be represent as a dataset of triples, which comprise two records and a label that indicates (e.g., a ground truth, etc.) whether underlying entities represented by the two records should match. These records may be of the same type, or (additionally, alternatively or optionally) may be of different types.

Examples of underlying entities represented in records in training instances as described herein may include, but are not necessarily limited to only, any of: organizational entities (e.g., companies, associations, government agencies, addresses at which products or services are to be delivered or rendered, etc.), physical entities (e.g., cameras, computers, devices, etc.), temporal entities (e.g., social events, sports events, educational events, birthdays, anniversaries, etc.), individual persons or groups, and so forth.

In some embodiments in which a label in a training instance (e.g., 104-1, 104-R, etc.) indicates a match for two records in the training instance, both of the records points to the same underlying entity. In some embodiments in which a label in a training instance (e.g., 104-1, 104-R, etc.) indicates a non-match for two records in the training instance, both of the records may point to the same type of underlying entities, but different underlying entities. In some embodiments in which a label in a training instance (e.g., 104-1, 104-R, etc.) indicates a non-match for two records in the training instance, the records may point to different types of underlying entities.

Training instances in the training dataset (102) are used as training examples to train, or to be used by, a match rule generator 106 in the system, to generate a set of match rules 108. The set of match rules (108) may comprise one or more match rules 108-1, etc. Each match rule (e.g., 108-1, etc.) in the set of match rules (108) may comprise one or more (e.g., conjunctive, etc.) predicates each of which corresponds to a feature extractable (or extracted) from training instances in the training dataset (102). For example, a match rule (e.g., 108-1, etc.) in the set of match rules (108) may comprise one or more predicates 110-1, 110-2, etc.

The set of match rules (108) as generated by the match rule generator (106) based on the training dataset (102) may be used by a match rule applicator 112 to determine whether two non-training records (e.g., in a table, in a plurality of non-training records, etc.) refer to the same entity or different entities.

2.1. Generating Predicates in Match Rules

FIG. 1B illustrates a part of an example machine learning workflow (e.g., 100 of FIG. 1A, etc.) for extracting features from training instances in a training dataset (e.g., 102, etc.) and generating predicates in match rules (e.g., 108, etc.) based on the extracted features. Each training instance (e.g., 104-1, 104-R, etc.) in the training dataset (102) may comprise a pair of (training) records with a first training record 114-1 having data field values 116-1-1, 116-1-2, etc., and a second training record 114-2 having data field values 116-2-1, 116-2-2, etc. Each such training instance (104-1) in the training dataset (102) may comprise a label 118 indicating whether these two records (104-1 and 114-2) are a match (e.g., referring to the same underlying entity, etc.) or a non-match (e.g., referring to different underlying entities, etc.). Some or all of the training instances in the training dataset (102) may be generated by incorporating continuous machine learning, manual input, background knowledge, domain knowledge, human expert input, etc.

In some embodiments, the data field values (116-1-1, 116-1-2, etc.) in the first training record (114-1) of the training instance (114-1) and the data field values (116-2-1, 116-2-2, etc.) in the second training record (114-2) of the same training instance (114-1) are field values for the same set of database fields (e.g., same columns of a database table, same columns of a database view, same columns of a result set, etc.).

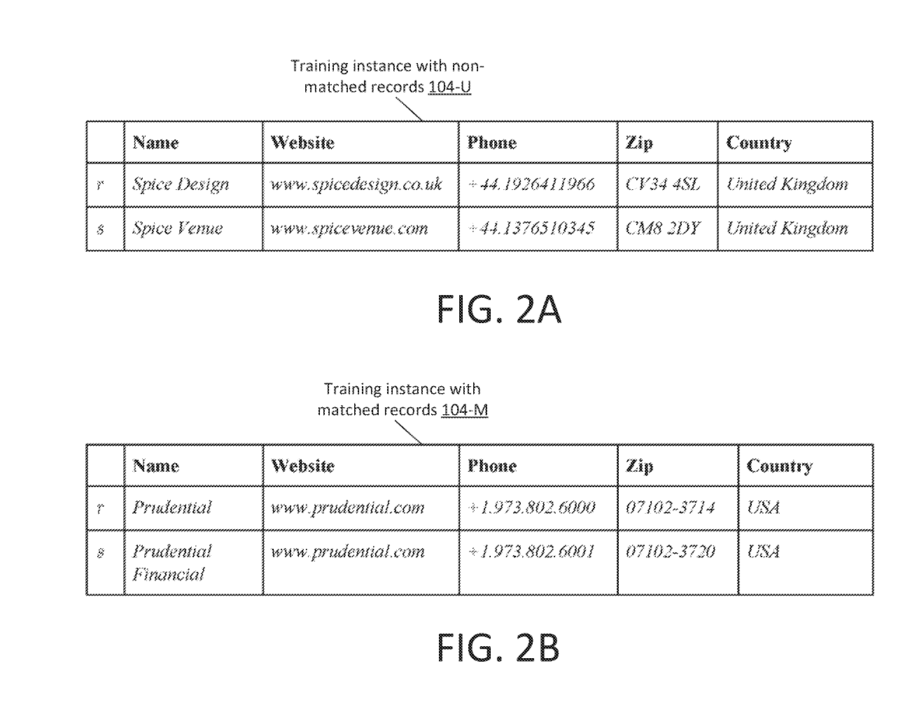

FIG. 2A and FIG. 2B illustrate two example training instances 104-U and 104-M. As illustrated in FIG. 2A, the training instance 104-U comprises two records (e.g., rows denoted as “r” and “s” respectively) each of which comprising data field values for the same set of data fields (e.g., columns, etc.) such as “Name”, “Website”, “Phone”, “Zip”, “Country”, etc. Similarly, as illustrated in FIG. 2B, the training instance 104-M comprises two records (e.g., rows denoted as “r” and “s” respectively) each of which comprising data field values for the same set of data fields such as “Name”, “Website”, “Phone”, “Zip”, “Country”, etc.

In addition, the training instance (104-U) comprises a label (not shown) indicating that the records in the training instance (104-U) does not match (referring to different underlying company or organizational entities). In contrast, the training instance (104-M) comprises a label (not shown) indicating that the records in the training instance (104-U) do match (referring to the same underlying company or organizational entity).

Referring to FIG. 1A and FIG. 1B, in some embodiments, the match rule generator (106), or a feature extractor 120 therein, extracts features from each of some or all of records of the training instances (e.g., 104-1, 104-R, etc.) in the training dataset (102). The features to be extracted from the training instances (e.g., 104-1, 104-R, 104-U, 104-M, etc.) and/or specific methods of extracting the features may be determined or specified based at least in part on continuous machine learning, manual input, background knowledge, domain knowledge, human expert input, etc.

In some embodiments, instances of a feature in the extracted features may be generated from some or all of a data field's values in records. For example, for underlying company entities as represented in the training instances 104-U and 104-R, the extracted features may be one or more of: key words from the “Name” data field, counts of words in the “Name” data field, base URLs from the “Web” data field, domain names from the “Web” data field, IP addresses from the “Web” data field, a prefix in the “Phone” field, and so forth.

For example, an instance of a “domain name” feature in the extracted features may be generated from each record (as illustrated in FIG. 2A and FIG. 2B) or a data field value for the “Web” data field therein. From the record denoted as “r” in the training instance (104-U) or the data field value “www.spicedesign.co.uk” for the “web” data field therein, a string value “spicedesign.co.uk” may be generated as an instance of the “domain name” feature. From the record denoted as “s” in the training instance (104-U) or the data field value “www.spicevenue.com” for the “web” data field therein, a string value “spicevenue.com” may be generated as an instance of the “domain name” feature. From the record denoted as “r” in the training instance (104-M) or the data field value “www.prudential.com” for the “web” data field therein, a string value “prudential.com” may be generated as an instance of the “domain name” feature. From the record denoted as “s” in the training instance (104-M) or the data field value “www.prudential.com” for the “web” data field therein, a string value “prudential.com” may be generated as an instance of the “domain name” feature.

Different features may use different feature extraction methods to generate their respective instances. For example, instances of a “phone prefix” feature in the extracted features may be generated from prefixes (e.g., the first 7 numbers, the first 10 numbers, etc.) of data field values for the “Phone” data field in the records as illustrated in FIG. 2A and FIG. 2B.

Additionally, optionally or alternatively, different conversion functions (e.g., string or number manipulation/conversion functions, etc.), different postfixes, different keywords, different lengths, different value types (e.g., strings, numbers, dates, times, conditions, etc.), etc., may be used to generate instances of different features in the extracted features.

In some embodiments, each feature in the extracted features corresponds to at most one data field in records in the training instances (e.g., 104-1, 104-R, etc.) in the training dataset (102). More specifically, each instance of such a feature may be derived from a data field value for the corresponding data field in one of the records.

In some embodiments, at least one feature in the extracted features corresponds to more than one data fields in records in the training instances (e.g., 104-1, 104-R, etc.) in the training dataset (102). More specifically, each instance of such a feature may be derived from multiple data field values for the multiple corresponding data fields in one of the records.

Let (r, s, l) denote a training instance (e.g., any of training instances such as 104-1, 104-R, etc.) in the training dataset (102), where r and s denote a pair of records and l denotes a label indicating either a match (e.g., positive, 1, true, etc.) or a non-match (e.g., negative, 0, false, etc.) for the records.

For the purpose of illustration only, n features are extracted from data field values of records of the training instances (e.g., 104-1, 104-R, etc.) in the training dataset (102), where n is a non-zero positive integer. Some or all of these features may be used generate predicates in match rules to predict the label l.

From the pair of records (r, s) in the training instance (104), two instances (e.g., a value, a string, a number, etc.) of each of the n features may be generated from data field values in the records, respectively, in the pair of records (r, s) in the training instance (104).

For example, the two records (representing underlying company entities) in the training instance (104-U) as illustrated in FIG. 2A may be respectively used to generate two instances of the extracted features from some or all of data field values in data fields such as “Name”, “Web”, “Phone”, “Zip”, “Country”, and so forth. Similarly, the two records (representing underlying company entities) in the training instance (104-M) as illustrated in FIG. 2B may be respectively used to generate two instances of the extracted features from some or all of data field values in the data fields “Name”, “Web”, “Phone”, “Zip”, “Country”.

For each feature in the n features, a match score algorithm may be used to compute a match score between two instances of each such feature, where the two instances are respectively generated from the two records in the training instance (r, s, l). In some embodiments, each of some or all of match scores as described herein may be normalized into a value in a normalized value range such as [0.0, 1.0]. A match score may be used to measure how similar two instances (or two values) of the same feature are. The higher the resemblance (or similarity) between the two instances of the same feature, the closer the match score is to 1.0.

By way of example but not limitation, in some embodiments, a match score between (company) names (e.g., the data field “Name” in the FIG. 2A and FIG. 2B, etc.) may be computed using Edit Distance as follows:

$$MatchScore ( x , y ) = \frac{max ( \vert x \vert , \vert y \vert ) - EditDistance ( x , y )}{max ( \vert x \vert , \vert y \vert )} \qquad ( 1 )$$

Based on the above formula in expression (1), a match score between a first company name “The Hershey Company” and a second company name “Hershey Company” is 0.789.

Additionally, optionally or alternatively, in some embodiments, a match score between (company) phone numbers (e.g., the data field “Phone” in the FIG. 2A and FIG. 2B, etc.) may be computed using Longest Prefix Length as follows:

$$MatchScore ( x , y ) = \frac{LongestPrefix ( x , y )}{max ( \vert x \vert , \vert y \vert )} \qquad ( 2 )$$

Based on the above formula in expression (2), a match score between a first phone number “+1.973.802.6000” and a second phone number “+1.973.802.7184 is 0.6.

Based on match scores computed based on two instances of each of the n features as derived from the pair of the records in the training instance (104-1), the match rule generator (106), or the feature extractor (120) therein, produces a match score vector z (for the training instance (104-1)) having a plurality of vector components storing a plurality of feature-level match scores as follows

\vec{x}=(m₁,m₂,m₃, . . . ,mₙ) (3)

As a result, an individual match score vector (e.g., in a plurality of match score vectors, etc.) as illustrated in expression (3) above can be produced for each training instance (e.g., in a plurality of training instances, etc.) in the training dataset (102).

Match scores for a feature (e.g., any one of m₁, m₂, etc.) from all the match score vectors produced for all the training instances in the training dataset (102) form a distribution of training match scores for the feature. In some embodiments, a match score threshold for the feature can be automatically determined based on the distribution of training match scores for the feature.

In some embodiments, a cost function (e.g., an objective function, a function measures errors for predictions, etc.) can be used, along with a distribution of training match scores as derived from the training instances of the training dataset (102 for a feature as described herein, to automatically determine a match score threshold for the feature. Multiple match score thresholds for the feature may be used in non-binary cases to make non-binary predictions for the feature. A single match score threshold for the feature may be used in binary cases to make binary predictions (e.g., match or non-match, positive or negative, true or false, 0 or 1, etc.) for the feature.

The match score threshold can be automatically determined for making binary predictions (or predicted labels) as to whether a given pair of (e.g., training, non-training, etc.) records (r, s) is a match or a non-match.

Techniques as described herein can be applied to a wide variety of operational scenarios. By way of example but not limitation, in some operational scenarios, precision (or positive predictive value) of a “match” prediction is more important than recall (or sensitivity) of the “match” prediction. In these operational scenarios, missed matches are more tolerable than false matches; thus, less error may be ascribed or assigned to a missed match than a false match in a cost function.

An example cost function (e.g., error function, objective function or simply objective, etc.) denoted as “Error (Feature, X)” may be constructed using a weighted version of (0-1) losses for false positives (e.g., 1 for each false positive or false negative, 0 for each true positive or true negative, etc.) and false negatives as follows:

Error(Feature,X)=w*num_false_positives+(1−w)*num_false_negatives (4)

where “Feature” denotes the extracted features or any given feature (for which a match score threshold is to be determined) in the extracted features; “X” denotes the training dataset (102); “num_false_positives” denotes a total number of false positives generated by predictions based on a match score threshold of the match score of the given feature; “num_false_negatives” denotes a total number of false negatives generated by predictions based on the match score threshold; “w” denotes a weight parameter with a value in [0, 1] that captures the relative importance of precision to recall. In some embodiments, the weight parameter “w” may be preset or configurable at runtime. In some embodiments, the weight parameter “w” is set to a value close to one (1). Each training instance, or two records therein, can be used to generate two instances of the extracted feature to be matched. A match score can be computed for the two instances, for example based on a match score function (or a similarity measure) as illustrated in expression (1) or (2). This match score computed from the two instances of each such training instance can be compared with a match score threshold (denoted as “Thresh”) to predict whether the two instances are a match or a non-match. The prediction of the match or non-match can be compared with the label in each such training instance to determine whether the prediction is a false positive, false negative, true positive or true negative. This can be repeated for each training instance of available training instances in a training dataset. As a result, all false positives and all false negatives can be determined for all the available training instances in the training dataset. Given the total number of the false positives and the total number of the false negatives, an error (denoted as “Error (Feature, thresh, X)”) can be determined according to expression (4) for any suitable match score threshold “thresh”. Note that the error can vary if the match score threshold is changed.

For the purpose of illustration only, the training dataset (102), denoted as “X” has 12 training instances or training examples of which 5 are labeled positives and the other 7 are labeled negatives. The weight parameter “w” is set to 0.9 to emphasize precision over recall.

Given such a training data set “X”, a baseline error can be computed using the cost function in expression (4) above, and is 6.8 (e.g., 0.9 x all 7 negatives mis-predicted as (false) positives+0.1 x all 5 positives mis-predicted as (false) negatives, etc.). Any rule that is mined under techniques as described herein based on any combination of match score thresholds for the extracted features would have an error no more than this baseline error.

Techniques as described herein can be applied to automatically determine or compute a match score threshold for each feature in the extracted features. For example, a match score threshold may be computed for a name related feature extracted from the “Name” data field in a training dataset (e.g., 102) comprising training instances with records representing company entities such as illustrated in FIGS. 2A and 2B. Based on each pair of instances for the name related feature generated from data field values for the “Name” data field in a pair of records in each training instance in the training dataset (102), a match score can be computed for the training instance, for example, based on similarity-based functions such as illustrated in expressions (1) and (2) above, or other match score functions.

For each training instance, a tuple of the form (a, b) may be used to store or represent the training instance identifier “a” and the match score “b” computed for the training instance. As a result, a distribution of match scores for all the training instances for the name-related feature may be generated and represented as an array of tuples “Name_Score” as follows:

Name_Score={(1,0.73),(2,0.8),(3,0.85),(4,1.0),(5,0.78),(6,0.53),(7,0.31),(8,0.74),(9,0.78),(10,0.64),(11,0.7),(12,0.63)} (5)

where the first five tuples in the array of tuples “Name_Score” is labeled (in the training dataset (102) or X) positive; the last seven tuples in the array of tuples “Name_Score” is labeled (in the training dataset (102) or X) negative.

A variety of optimization methods may be used to determine or find an optimal match score that best separates the positives (or training instances each of which is labeled positive) from the negatives (or training instances each of which is labeled negative) in connection with a feature in the extracted features. The optimal match score can be set as the match score threshold for the feature. An example procedure or optimization method of determining a match score threshold (e.g., for the name related features with the distribution of match scores as indicated in expression (5) above, etc.) based on Exhaustive Grid Search is illustrated in TABLE 1 below.

```
TABLE 1
import numpy as np
# The weight parameter set to 0.9
w = 0.9
def computeError(num_false_positives, num_false_negatives):
  return w * num_false_positives + (1 − w) * num_false_negatives
# The positive and negative match scores for the name feature
positives = [(1, 0.73), (2, 0.8), (3, 0.85), (4, 1.0), (5, 0.78)]
negatives = [(6, 0.53), (7, 0.31), (8, 0.74), (9, 0.78), (10, 0.64), (11, 0.7),
(12, 0.63)]
# Thresholds for the Grid Search
thresholds = np.arange(0, 1.01, 0.01)
# The Baseline Error Rate
error = computeError(7, 5)
print (“The global error is {0}”.format(error))
# The best threshold computed at the end of the Grid Search
bestThreshold = 0
# Exhaustive Grid Search
for threshold in thresholds:
  falsePositiveCount = sum([1 if negative[1] >= threshold else 0 for
  negative in negatives])
  falseNegativeCount = sum([1 if positive[1] < threshold else 0 for
  positive in positives])
  latestError = computeError(falsePositiveCount, falseNegativeCount)
  if latestError < error:
    error = latestError
    bestThreshold = threshold
  end if
end for
print (“The best threshold is {0} and the associated error is
{1}”.format(bestThreshold, error))
```

As can be seen above, a match score threshold (denoted as “bestThreshold” in TABLE 1) and a match error (denoted as “error” in TABLE 1) can be determined for the name-related field based on the distribution of match scores as represented by the positives (denoted as “positives” in TABLE 1) and the negatives (denoted as “negatives” in TABLE 1) in the array of tuples for the training instances. More specifically, the match score threshold for the name-related field is 0.79.

Procedures or optimization methods similar to that as illustrated in TABLE 1 may be performed by the match rule generator (106 of FIG. 1A) or the feature extractor (120 of FIG. 1B) therein for each feature in the extracted features to generate a feature-threshold array 122 (of FIG. 1B) each of which corresponds to a respective feature in the extracted features, is denoted in the form (f, t), and comprises a feature identifier “f” for the respective feature and a match score threshold “t” computed or otherwise determined for the respective feature.

As illustrated in FIG. 1B, the feature-threshold array (122) and their respective errors as measured by the cost function (e.g., error function, objective function, etc.) may be used as input by the match rule generator (106 of FIG. 1A) or a predicate set generator 126 therein to (e.g., perform supervised machine learning to, etc.) generate one or more match rules (e.g., 108, etc.). Each match rule (e.g., 108-1, etc.) of the one or more match rules (108) generated by the match rule generator (106) may be represented by a prediction clause comprising one or more predicates (e.g., 110-1, 110-2, etc.).

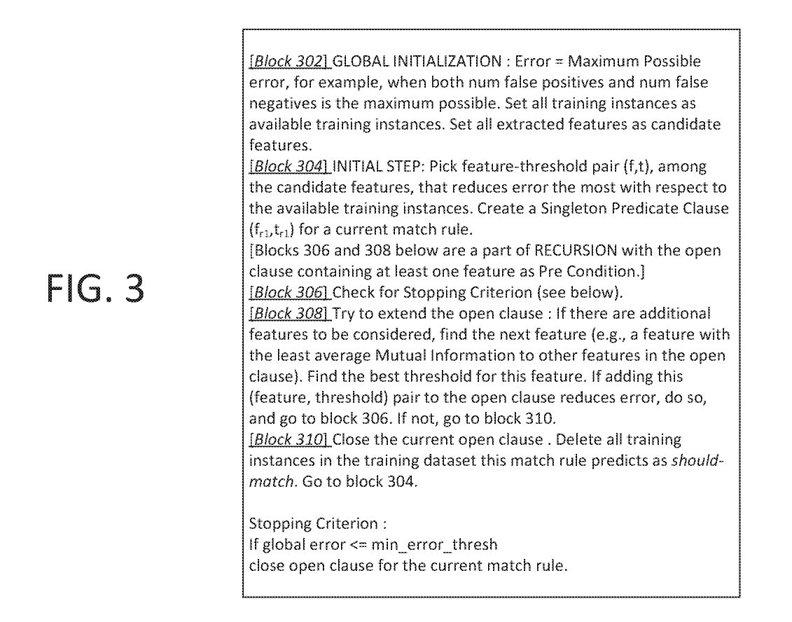

FIG. 3 illustrates an example process flow or (method) of deriving one or more match rules (e.g., 108 of FIG. 1A, FIG. 1B, FIG. 1C or FIG. 1D, etc.) based on a feature-threshold array (e.g., 122 of FIG. 1B, etc.) and their respective errors as measured by a cost function (e.g., error function, objective function, including but not limited to expression (4) above, etc.).

In block 302, the match rule generator (106 of FIG. 1A) sets an initial value for a match rule error (for a current match rule to be generated) to a maximum possible error (e.g., the largest error possible for the cost function, etc.). For example, the initial value for the match rule error for the current match rule may be set to the maximum possible error as computed with the cost function (e.g., in expression (4) above, etc.) when both the total number of false positives and the total number of false negatives are at the maximum values possible. When no predicates has been generated based on any of the available candidate features for the current match rule, the current match rule may be initially represented as an open predicate clause (e.g., with no predicates, etc.).

When no match rule has been generated from the extracted features, all extracted features may be used as available candidate features for generating the current (e.g., the very first, etc.) match rule. In some embodiments, some or all features (in the extracted features) that have been used in existing match rules are removed from available candidate features for generating the current (e.g., not the very first, subsequent, etc.) match rule.

The available candidate features for generating the current match rule may be represented as a plurality feature-threshold pairs. Each feature-threshold pair (f, t) in the plurality of feature-threshold pairs can represent an available candidate feature with a feature identifier “f” identifying the available candidate feature and a match score threshold “t” computed (e.g., as illustrated in TABLE 1, etc.) for the available candidate feature.

Each available candidate feature has a respective error that is computed against currently available training instances when the match score threshold is determined based on the currently available training instances.

Initially when no match rule has been generated, all training instances in the training dataset (102) are available training instances for generating the current (e.g., the very first, etc.) match rule. In some embodiments, some or all training instances that have been predicted as match (or positive) in existing match rules are removed from available training instances for generating the current (e.g., not the very first, subsequent, etc.) match rule.

In block 304, the match rule generator (106 of FIG. 1A) selects the (e.g., very, etc.) first feature among all the available candidate features for generating the current match rule as the first feature, and removes the selected first feature from the available candidate features for generating the current match rule.

The first feature (denoted as “rl”) for the current match rule may be selected, as an available candidate feature from among all the available candidate features for generating the current match rule, with the lowest respective error among all respective errors of all the available candidate features.

A predicate may be generated based on the selected first feature “rl” and may be included in the current match rule by incorporating the predicate into the open predicate clause (e.g., thereby generating a singleton clause at this point, etc.) that represents the current match rule. The predicate (corresponding to the first feature) to be incorporated into the current match rule may be specified/defined as follows:

mᵣₗ≥tᵣₗ (6)

where given a pair of (e.g., training, non-training, etc.) records whose underlying entities are to be predicted by the predicate as a match or a non-match, “mᵣₗ” denotes a match score computed for the first feature “rl” based on instances of the first feature “rl” generated from the pair of records; “tᵣₗ” denotes the match score threshold to be applied to match scores computed for the first feature “rl”. The match score threshold “tᵣₗ” can be determined based on the available training instances for generating the current match rule.

In block 306, the match rule generator (106 of FIG. 1A) determines whether a stop criterion is satisfied, for example by determining whether the match rule error (or global error) for the current match rule has a value less than a minimum error threshold (denoted as “min_error_thresh”). The match rule error (or the global error) may be computed as the error of the full set of match clauses comprising all closed clauses plus the currently open clause on the original training dataset with all training instances, which may be different from the error of the current open clause based on the currently available training instances. By way of example, suppose the current open match rule (or the match rule with the current open clause) contains two predicates, together with their accompanying thresholds (fᵢ, tᵢ) and (fⱼ, tⱼ), where fᵢ and fⱼ denote the features in the two predicates respectively; tᵢ and tⱼ denote the (per-feature) match score thresholds for the features fᵢ and fⱼ respectively. The (currently open) match rule with two predicates in it predicts a match on a (training or non-training) instance if and only if both predicates pass (or indicate true). A false positive for this match rule is a training instance that is a negative (or the label in the training instance indicates a non-match as ground truth) yet the training instance still satisfies both predicates: mᵢ>=tᵢ AND mⱼ>=tⱼ, where mᵢ and mⱼ are the (per-feature) match scores for the feature fᵢ and fⱼ, for example as computed with expression (1) or (2) above. Likewise, a false negative for this match rule is a training instance that is a positive (or the label in the training instance indicates a match as ground truth) yet the training instance fails at least one of the predicates in the match rule: mᵢ<tᵢ OR mⱼ<tⱼ. where m₁ and mⱼ are the (per-feature) match scores for the feature fᵢ and fⱼ, for example as computed with expression (1) or (2) above. The total number of the false positives and the total number of the false negatives, as computed from all the training instances in the original training dataset, may be used to compute the match rule error (or the global error) as described herein, for example according to expression (4) above. This match rule error may be used to determine whether the stop criterion is satisfied or whether the addition of a predicate reduces error, for example in block 308 below.

In response to determining that the match rule error for the current match rule has a value no more than the minimum error threshold “min_error_thresh”, the open predicate clause for the current match rule is closed. This now closed predicate clause is determined to represent the current match rule in determining whether any given pair of records such as records/rows in the same database table, records/rows in the same database view, records/rows in the same result set, comprising the same columns, and so forth, are a match or a non-match. The process flow goes back to block 304 to determine a subsequent match rule. In some embodiments, some or all of the features used to generate predicates in existing match rules up to the current match rule are removed from the available candidate features for generating the subsequent match rule after the current match rule. In some embodiments, some or all of the available training instances that have been predicted as matches (or positives) by the existing match rules up to the current match rule are removed from the available training instances for generating the subsequent match rule after the current match rule. The subsequent rule is set to be the (new) current match rule in block 304.

On the other hand, in response to determining that the match rule error for generating the current match rule has a value greater than the minimum error threshold “min_error_thresh”, the process flow goes to block 308.

In block 308, the match rule generator (106 of FIG. 1A) selects a subsequent feature, after the very first feature and up to the last feature for which a predicate is generated and included in the current match rule, among all the available candidate features for generating the current match rule as the first feature, and removes the (selected) subsequent feature from the available candidate features for generating the current match rule.

The subsequent feature (denoted as “ri”) for the current match rule may be selected, as an available candidate feature from among all the available candidate features for generating the current match rule, with the least average Mutual Information to other features (or predicates generated based on these other features) already included in the open clause representing the current match rule in terms of predictions on matches or non-matches among some or all training instances in the training dataset (102) such as the available training instances for generating the current match rule and so forth. For example, mutual information between any two features as described herein may be computed based on joint and marginal probabilities of predictions values of the two features over all combinations of prediction values of the two features. the lowest respective error among all respective errors of all the candidate features.

Additionally, optionally or alternatively, the subsequent feature “ri” for the current match rule may be selected, as an available candidate feature from among all the available candidate features for generating the current match rule, with the lowest respective error among all respective errors of all the available candidate features.

In some embodiments, the match rule generator (106) tries or attempts to include the selected subsequent feature into the current match rule. The match rule generator (106) may determine whether the inclusion of the selected subsequent feature into the current match rule reduces the match rule error, for example by a minimum match error reduction threshold (e.g., greater than 1%, 5%, 10%, by a preset or configurable reduction value, etc.), in comparison with the match rule error of the current match rule without the inclusion of the selected subsequent feature. The match rule error as described herein can be computed for the current match rule with or without the inclusion of the selected subsequent feature using ground truths indicated by labels of some or all training dataset (102) such as the available training instances for generating the current match rule and so forth. The selected subsequent feature (e.g., each available candidate feature, etc.) may not be able to (e.g., sufficiently, etc.) reduce the match rule error if the selected subsequent feature happens to be highly correlated with some or all of the already included feature(s) in the open clause.

In some embodiments, in response to determining that the inclusion of the selected subsequent feature into the current match rule does not (e.g., sufficiently, as compared with the minimum match error reduction threshold, etc.) reduce the match rule error in comparison with the match rule error of the current match rule without the inclusion of the selected subsequent feature, the open clause for the current match rule is closed so that the current match rule is (e.g., finally, etc.) determined based on the already included features or predicates generated based on the already included features. This now closed predicate clause is determined to represent the current match rule in determining whether any given pair of records such as records/rows in the same database table, records/rows in the same database view, records/rows in the same result set, comprising the same columns, and so forth, are a match or a non-match. The process flow goes back to block 304 to determine a subsequent match rule. In some embodiments, some or all of the features used to generate predicates in existing match rules up to the current match rule are removed from the available candidate features for generating the subsequent match rule after the current match rule. In some embodiments, some or all of the available training instances that have been predicted as matches (or positives) by the existing match rules up to the current match rule are removed from the available training instances for generating the subsequent match rule after the current match rule. The subsequent rule is set to be the (new) current match rule in block 304.

In some embodiments, in response to determining that the inclusion of the selected subsequent feature into the current match rule (e.g., sufficiently, as compared with the minimum match error reduction threshold, etc.) reduces the match rule error in comparison with the match rule error of the current match rule without the inclusion of the selected subsequent feature, a subsequent predicate may be generated based on the selected subsequent feature “ri” and may be included in the current match rule by incorporating the predicate into the open predicate clause that represents the current match rule. The predicate (corresponding to the selected subsequent feature) to be incorporated into the current match rule may be specified/defined as follows:

mᵣᵢ≥tᵣᵢ (7)

where given a pair of (e.g., training, non-training, etc.) records whose underlying entities are to be predicted by the predicate as a match or a non-match, “mᵣₗ” denotes a match score computed for the selected subsequent feature “ri” based on instances of the selected subsequent feature “ri” generated from the pair of records; “tᵣᵢ” denotes the match score threshold to be applied to match scores computed for the selected subsequent feature “ri”. The match score threshold “tᵣᵢ” can be determined based on the available training instances for generating the current match rule. The process flow then goes to block 306 (if there are available candidate features left; otherwise, the process flow ends).

For the purpose of illustration only, consider a training dataset (e.g., 102, etc.) that comprises a large number (e.g., tens of millions, etc.) of training instances for products such as digital cameras, personal computers, tablet computers, laptops, mobile handsets, and so forth, of various manufactures, brands, models, etc. Each training instance in the training instances may comprise (a) a pair of records each of which has values for a number of fields (or columns) such as product ID (denoted as “PI”), product name (denoted as “PN”), product family (denoted as “PF”), category, stock keeping unit (SKU), and so forth, and (b) a label (e.g., ground truth, expert input, a result from previous machine learning, etc.) indicating whether the records (or underlying products as represented by the records, etc.) in the pair of records in each such training instance is a match or a non-match.

Initially, all or substantially all of the training instances in the training dataset (102) are available instances for generating match rules for predicting whether any two records representing underlying products is a match or a non-match.

A plurality of features can be extracted from the values of the fields in the records in the training instances. Techniques as described herein can support a wide variety of relationships between the extracted fields and the fields in the records. In an example, each field such as SKU, PF, etc., may be considered as a feature. In another example, a part (e.g., “Canon” in PN, “CMX123” in PN, a word count in PN, etc.) such as prefix, suffix, specific character positions, one or more keywords, the number of words, and so forth, may be extracted or generated from values of each field as instances of a specific feature in the extracted features. In yet another example, combinations (e.g., a part of PN plus PF, etc.) of all or parts of values of multiple fields may be extracted or generated as instances of a specific feature in the extracted features. Any combination in a wide variety of manipulation functions, extraction functions, concatenation functions, conversion functions, etc., of text, number, data, time, etc., may be used to extract or generate instances of a feature as described herein from a single field, or multiple fields of the training instances in the training dataset (102).

Additionally, optionally or alternatively, any combination in a wide variety of similarity measures (e.g., edit distance, the count of shared distinct keywords over the count all distinct keywords, etc.) may be used to determine similarities between two instances of the same feature in the extracted features. There is no need for two records and/or two fields to have exactly the same field values in order to be conservatively determined as a match by a match rule or a predicate therein. Similarity may be fuzzily measured rather than exact matches. Additionally, optionally or alternatively, instead of using just true (or 1) or false (0), a probability of similarity other than 0 or 1 may also be generated based on a similarity measure as described herein. What fields, what values, etc., are to be used in measuring similarity and predicting matches may be determined based on a combination of expert input, ground truths, conflicting features, combinations of features, cross-domain knowledge, and so forth. For example, “Cannon camera CMX123” and “Cannon CMX123” may be considered similar for the “PN” field.

In the present example, in block 304 of FIG. 3C, in which the match rule generator (106 of FIG. 1A) is to select the (very) first feature among all the available candidate features for generating a current match rule (e.g., the very first match rule, etc.) as the first feature, a feature represented by the “SKU” field may be automatically determined as generating the lowest prediction error (or match rule error) among all the features represented or extracted by the fields of the training instances in the training dataset. Thus, the “SKU” field/feature may be selected as the (very) first feature for the very first match rule, and then may be removed from the available candidate features for generating the current match rule.

In contrast, a field such as “PF” tends to generate large prediction errors, as many different products may be in the same product family. Thus, the “PF” field may not be selected as the very first field for the very first match rule.

A predicate may be generated based on the selected “SKU” field/feature (or the “rl” feature) to be incorporated into an open predicate clause (e.g., thereby generating a singleton clause at this point, etc.) that represents the current match rule or the very first match rule at this point. The predicate (corresponding to the first feature) to be incorporated into the current match rule may be specified/defined as illustrated in expression (6). The match score threshold “tᵣₗ” can be determined, for example, as 0.5, based on the available training instances for generating the current match rule. When a similarity computed based on two instances of the “SKU” field from a pair of records is close to 1, the predicate predicts the two records as likely a match. On the other hand, when the similarity computed based on the two instances of the “SKU” field from the pair of records is close to zero, the predicate predicts the two records likely not a match. It is likely that every product has a distinct SKU. Thus, these predictions are likely to be relatively accurate, for example as compared with a field such as “PF”.

Other fields and features extracted from these other fields such as product hierarchy fields/features (e.g., smart cameras, electronic goods, the “PN” field, the “PF” field, etc.), price field/feature, etc., may be highly correlated (e.g., have relatively high mutual information, etc.) with the “SKU” field/feature and may not be able to (e.g., significantly, etc.) reduce the match rule error generated by the current match rule that incorporates the “SKU” field/feature.

By way of illustration but not limitation, the process flow of FIG. 3 may thus determine that the very first rule comprises the single predicate generated based on the “SKU” field/feature and that the very first rule with the single predicate meet the stop criterion as used in the process flow of FIG. 3.

While the first match rule based on the “SKU” field/feature may be a relatively accurate and reliable match rule for most training instances, there may be other positives or matches in the training instances for which the first match rule may predict as negatives or non-matches. In a first example, the first match rule may not make correct predictions when records are not fully clean (e.g., missing information, incorrect information, etc.) and may not contain correct information in the “SKU” field/feature in some training instances, and so forth. In a second example, the first match rule may not make correct predictions in operational scenarios in which records that represent other entities (e.g., company entities as illustrated in FIG. 2A and FIG. 2B, etc.), events, etc., may or may not even have a field similar to the “SKU” field in records that represent products such as cameras, electronic goods, etc.

In the present example, the process flow of FIG. 3 continues to (e.g., recursively, iteratively, etc.) search through the remaining features in the extracted features from the training dataset (102) to generate additional match rules (e.g., in addition to the very first match rule based on the “SKU” field/feature, etc.) and/or additional predicates. The search for the additional match rules may use remaining training instances in the training dataset (102) that are predicted to be negatives or non-matches by the first match rule. The same steps used in determining the first match rule may be used to generate the second match rule if any, the third match rule if any, etc.

For example, through the recursive or iterative process flow of FIG. 3, the second match rule may incorporate the first predicate that makes predictions based on determining whether match scores for the “PN” field/feature are no less than a specific match score threshold for the “PN” field/feature. Through the recursive or iterative process flow of FIG. 3, the second match rule may further incorporate the second predicate generated from the “price” field/feature, as it is determined that the “price” field/feature may share the least mutual information with the “PN” field/feature used to generate the first predicate in the second match rule. The second predicate in the second match rule may make a prediction based on determining whether match scores for the “price” field/feature is no less than a specific match score threshold for the “price” field/feature.

2.2. Applying Match Rules

FIG. 1C illustrates a part of an example machine learning workflow (e.g., 100 of FIG. 1A, etc.) for applying match rules (e.g., 108, etc.) by a match rule applicator (e.g., 112, etc.) to determine or predict whether any given pair of records (or underlying entities represented by the records) are a match or a non-match.

For example, a pair of (non-training) records 114-3 and 114-4 may be retrieved from a data repository (e.g., a multi-tenant database system that may comprise billions of records for hundreds of thousands or millions of organizations, etc.) such as an entity data store 138 and provided to the match rule applicator (112) as input.

The records (114-3 and 114-4) may include a first (non-training) record 114-3 having data field values 116-3-1, 116-3-2, etc., and a second (non-training) record 114-4 having data field values 116-4-1, 116-4-2, etc. Unlike a training instance, there may not be a provided label indicating whether these two records (104-3 and 114-4) are a match (e.g., referring to the same underlying entity, etc.) or a non-match (e.g., referring to different underlying entities, etc.). Rather, the match rules (108) generated by the match rule generator (106) from training instances in a training dataset (e.g., 102) are to be applied by the match rule applicator (112) to determine or make a prediction as to whether the records (114-3 and 114-4), or underlying entities represented therein, are a match or a non-match.

In some embodiments, the data field values (116-3-1, 116-3-2, etc.) in the first record (114-3) in the pair of records (114-3 and 114-4) and the data field values (116-4-1, 116-4-2, etc.) in the second record (114-3) of the same pair of records (114-3 and 114-4) are field values for the same set of database fields (e.g., same columns of a database table, same columns of a database view, same columns of a result set, etc.). Additionally, optionally or alternatively, the data field values (116-3-1, 116-3-2, etc.) in the first record (114-3) in the pair of records (114-3 and 114-4) and the data field values (116-4-1, 116-4-2, etc.) in the second record (114-3) of the same pair of records (114-3 and 114-4) are field values for the same or substantially the same set of database fields (e.g., same or substantially the same columns of a database table, same or substantially the same columns of a database view, same or substantially the same columns of a result set, etc.) in the training instances that are used to generate the match rules (108).

In some embodiments, the match rule applicator (112), or a feature extractor 120 (which may be the same as the feature extractor (120) of FIG. 1A or FIG. 1B) therein, extracts predicate features 136-1, 136-2, etc., from the first record (114-3) and the second record (114-4). Here, “predicate features” refer to features based on which predicates in the match rules (108) are generated. The predicate features (e.g., 136-1, 136-2, etc.) and/or specific methods of extracting the predicate features (e.g., 136-1, 136-2, etc.) may be the same as those used for generating the match rules (108) or the predicates therein.

For example, the first record (114-3) and the second record (114-4) may be respectively used to generate two instances of the predicate features (e.g., 136-1, 136-2, etc.) from some or all of data field values in data fields of the first record (114-3) and the second record (114-4).

For each predicate feature in the predicate features (e.g., 136-1, 136-2, etc.) that are included in the match rules (108) or the predicates therein, a match score algorithm that was used to generate match scores for the predicate feature (e.g., 136-1, 136-2, etc.) from training instances may be used to compute a match score between two instances of each such feature as generated from the data fields of the first record (114-3) and the second record (114-4), where the higher the resemblance (or similarity) between the two instances of the same feature, the closer the match score is to 1.0.

Based on match scores computed based on two instances of each of the predicate features (e.g., 136-1, 136-2, etc.) as derived from the first record (114-3) and the second record (114-4), the match rule applicator (112), or a match determinator 132 therein, compares the match scores with their respective match score thresholds in the predicates in the match rules (108) to generate a match result 134. In response to determining that each match score in any given match rule in the match rules (108) is above a corresponding match score threshold, the first record (114-3) and the second record (114-4) may be predicted as a match in the match result (134). Otherwise, the first record (114-3) and the second record (114-4) may be predicted as a non-match in the match result (134).

2.3. Inspecting and Editing Match Rules

FIG. 1D illustrates an example process flow for viewing and editing match rules (e.g., 108, etc.). In some embodiments, match rules (e.g., 108, etc.) as described herein may be stored in a match rule data store 140. A match rule editor UI 142 may be used to allow a user 144 to view or edit some or all of the match rules (108) or any predicate therein. In an example, the match rules (108) may be used to make a decision. The user (144) may view textual or graphic representation of any match rule or any predicate that plays a role in the decision. For example, in response to a customer service call, the user (144) can walk through the process of making the decision with a customer. In another example, the match rules (108)—including but not limited to any feature extraction methods used to extract predicate features for the match rules (108), match score or similarity computation methods for the predicate features, match score thresholds for the predicate features, and so forth—can be textually or graphically presented to the user (144) through the match rule editor UI (142). In some embodiments, through the match rule editor UI (142), the user (144) may edit, delete, add, update, etc., any of all of the match rules (108), including but not limited to the feature extraction methods used to extract the predicate features for the match rules (108), the match score or similarity computation methods for the predicate features, the match score thresholds for the predicate features, and so forth,

### 3.0 Example Embodiments

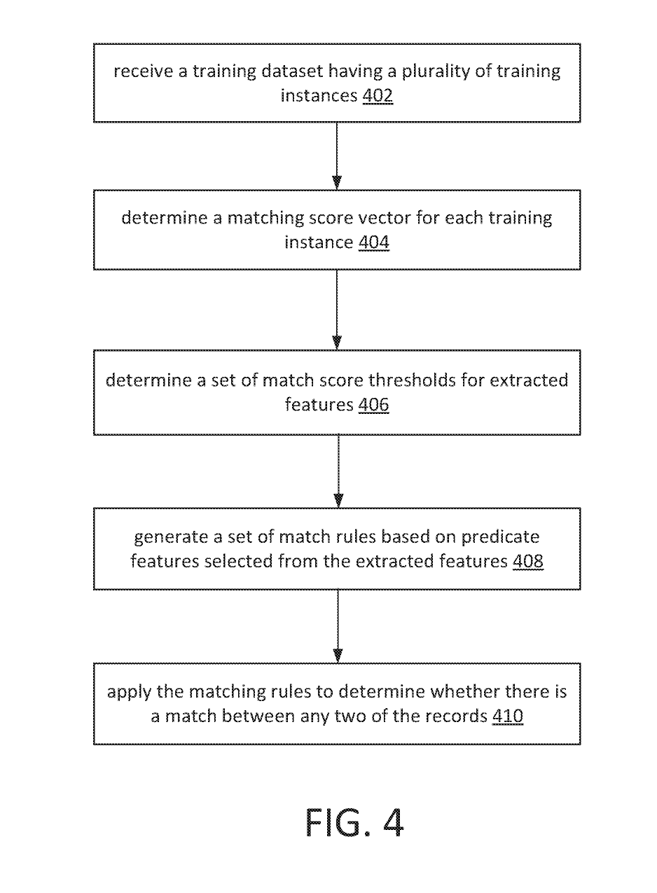

FIG. 4 illustrates an example process flow that may be implemented by a computing system (or device) as described herein. In block 402, a supervised machine learning system (e.g., implementing the workflow (100) of FIG. 1A, etc.) receives a training dataset having a plurality of training instances, each training instance in the plurality of training instances comprising (a) a pair of training records with a first record and a second record and (b) a label indicates whether there is a match between the first record and the second record, the first record having a first plurality of field values for a plurality of fields, the second record having a second plurality of field values for the plurality of field.

In block 404, the supervised machine learning system determines a matching score vector for each such training instance, the matching score vector comprising a set of components storing a set of match scores for a set of extracted features derived from the first plurality of field values and the second plurality of field values.

In block 406, based on a plurality of matching score vectors for the plurality of training instances in the training dataset and a match objective function, the supervised machine learning system determines a set of match score thresholds for the set of extracted features.

In block 408, the supervised machine learning system generates a set of match rules, each match rule in the set of match rules comprising a set of predicates based at least in part on a set of predicate features selected from the set of extracted features, each predicate in the set of predicates making a predication on whether two records match by comparing a match score derived from the two records against a match score threshold.

In block 410, the supervised machine learning system applies the set of matching rules to two or more records each having a plurality of field values for the plurality of fields to determine whether there is a match between any two of the two or more records.

In an embodiment, each match score thresholds in the set of match score thresholds is used for comparison with match scores of a respective feature in the set of extracted features, as computed from records having field values of the plurality of fields, to make match or non-match predictions with respect to the records; each such match score thresholds in the set of match score thresholds is obtained from a plurality of match scores of the respective feature, as computed from training records in a plurality of instances, by minimizing a match error based on the match objective function.

In an embodiment, the set of match rules comprises a match rule that are conjunctively joined by two or more predicates; the two or more predicates comprises a first predicate generated based on a first feature that is identified by a machine learning process as the most discriminating feature in the set of extracted features; the two or more predicates comprises a second predicate generated based on a second feature that is identified as having the least mutual information with the first feature.

In an embodiment, the two or more records belong to a set of database records among a plurality of sets of database records stored in a cloud-based computing system; each set of database records represent a respective type of entity among a plurality of different types of entities; the plurality of different types of entities includes at least one of: accounts, contacts, leads, company locations, company entities, products, shipping addresses, time events, or calendar entries.

In an embodiment, the set of match rules are initially generated fully automatically by a machine learning process from the plurality of training instances in the training dataset.

In an embodiment, the set of match rules comprises a match rule that is displayed to a user through a user interface and that is edited by the user through the user interface; an editing operation performed based on user input includes one of: modifying predicate composition of the match rule, modifying a match score threshold in a predicate in the match rule, modifying a feature extraction method for extracting a feature in a predicate in the match rule, or modifying a similarity function used to determine match scores for a feature in a predicate in the match rule.

In an embodiment, the set of match rules are among a plurality of sets of match rules generated at least in part by supervised machine learning implemented by one or more computing devices; the plurality of sets of match rules is applied by a computing system to provide at least one of: (a) automatic entity matching and recognition among a massive volume of data in the computing system, (b) data consistency across over a set of database tables across a plurality of instances of one or more datacenters in the computing system, (c) complete white-box information about a match or non-match decision made with any match rule in the plurality of sets of match rules in terms of specific predicates used in the match rule, specific feature extraction methods used in the specific predicates of the match rule, specific similarity measure used to compute match scores for the specific predicates of the match rule, specific match score threshold used to compare computed match scores for the specific predicates of the match rule, etc.

In some embodiments, process flows involving operations, methods, etc., as described herein can be performed through one or more computing devices or units.

In an embodiment, an apparatus comprises a processor and is configured to perform any of these operations, methods, process flows, etc.

In an embodiment, a non-transitory computer readable storage medium, storing software instructions, which when executed by one or more processors cause performance of any of these operations, methods, process flows, etc.

In an embodiment, a computing device comprising one or more processors and one or more storage media storing a set of instructions which, when executed by the one or more processors, cause performance of any of these operations, methods, process flows, etc. Note that, although separate embodiments are discussed herein, any combination of embodiments and/or partial embodiments discussed herein may be combined to form further embodiments.

### 4.0 Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

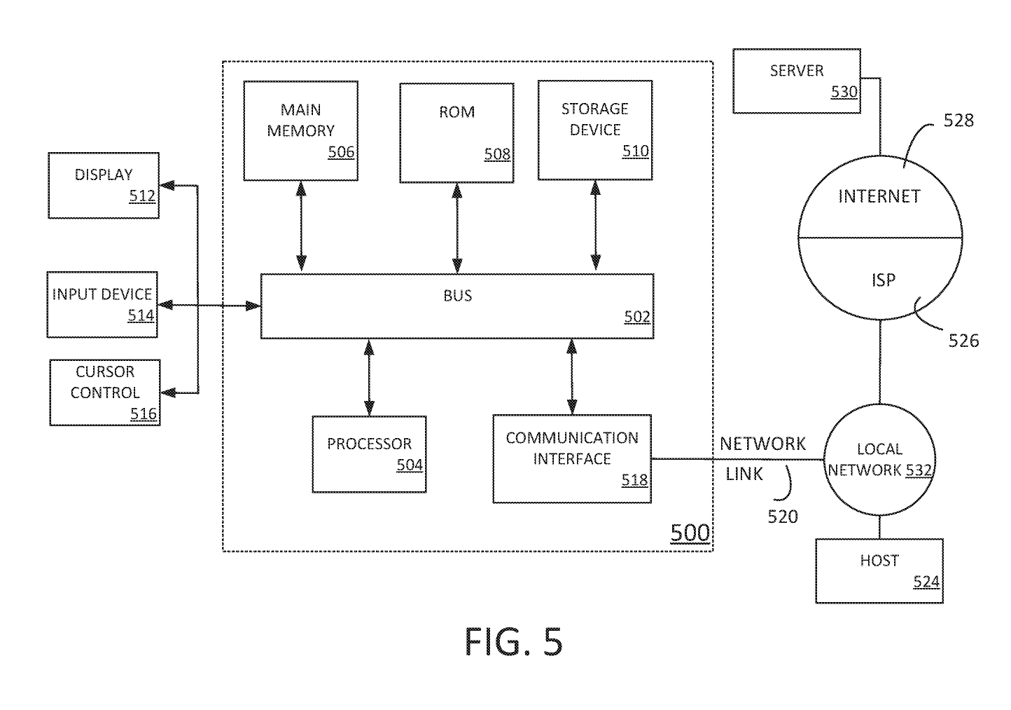

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is device-specific to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using device-specific hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 5.0 Equivalents, Extensions, Alternatives and Miscellaneous

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented machine learning method, comprising:
receiving a training dataset having a plurality of training instances, each training instance in the plurality of training instances comprising (a) a pair of training records with a first record and a second record and (b) a label indicates whether there is a match between the first record and the second record, the first record having a first plurality of field values for a plurality of fields, the second record having a second plurality of field values for the plurality of field;
determining a matching score vector for each such training instance, the matching score vector comprising a set of components storing a set of match scores for a set of extracted features derived from the first plurality of field values and the second plurality of field values;
based on a plurality of matching score vectors for the plurality of training instances in the training dataset and a match objective function, determining a set of match score thresholds for the set of extracted features;
generating a set of match rules, each match rule in the set of match rules comprising a set of predicates based at least in part on a set of predicate features selected from the set of extracted features, each predicate in the set of predicates making a predication on whether two records match by comparing a match score derived from the two records against a match score threshold;
applying the set of matching rules to two or more records each having a plurality of field values for the plurality of fields to determine whether there is a match between any two of the two or more records.

2. The method as recited in claim 1, wherein each match score thresholds in the set of match score thresholds is used for comparison with match scores of a respective feature in the set of extracted features, as computed from records having field values of the plurality of fields, to make match or non-match predictions with respect to the records; wherein each such match score thresholds in the set of match score thresholds is obtained from a plurality of match scores of the respective feature, as computed from training records in a plurality of instances, by minimizing a match error based on the match objective function.

3. The method as recited in claim 1, wherein the set of match rules comprises a match rule that are conjunctively joined by two or more predicates; wherein the two or more predicates comprises a first predicate generated based on a first feature that is identified by a machine learning process as the most discriminating feature in the set of extracted features; wherein the two or more predicates comprises a second predicate generated based on a second feature that is identified as having the least mutual information with the first feature.

4. The method as recited in claim 1, wherein the two or more records belong to a set of database records among a plurality of sets of database records stored in a cloud-based computing system; wherein each set of database records represent a respective type of entity among a plurality of different types of entities; wherein the plurality of different types of entities includes at least one of: accounts, contacts, leads, company locations, company entities, products, shipping addresses, time events, or calendar entries.

5. The method as recited in claim 1, wherein the set of match rules are initially generated fully automatically by a machine learning process from the plurality of training instances in the training dataset.

6. The method as recited in claim 1, wherein the set of match rules comprises a match rule that is displayed to a user through a user interface and that is edited by the user through the user interface; wherein an editing operation performed based on user input includes one of: modifying predicate composition of the match rule, modifying a match score threshold in a predicate in the match rule, modifying a feature extraction method for extracting a feature in a predicate in the match rule, or modifying a similarity function used to determine match scores for a feature in a predicate in the match rule.

7. The method as recited in claim 1, wherein the set of match rules are among a plurality of sets of match rules generated at least in part by supervised machine learning implemented by one or more computing devices; wherein the plurality of sets of match rules is applied by a computing system to provide at least one of: (a) automatic entity matching and recognition among a massive volume of data in the computing system, (b) data consistency across over a set of database tables across a plurality of instances of one or more datacenters in the computing system, or (c) complete white-box information about a match or non-match decision made with any match rule in the plurality of sets of match rules in terms of specific predicates used in the match rule, specific feature extraction methods used in the specific predicates of the match rule, specific similarity measure used to compute match scores for the specific predicates of the match rule, or specific match score threshold used to compare computed match scores for the specific predicates of the match rule.

8. One or more non-transitory computer readable media storing a program of instructions that is executable by a device to perform:
receiving a training dataset having a plurality of training instances, each training instance in the plurality of training instances comprising (a) a pair of training records with a first record and a second record and (b) a label indicates whether there is a match between the first record and the second record, the first record having a first plurality of field values for a plurality of fields, the second record having a second plurality of field values for the plurality of field;
determining a matching score vector for each such training instance, the matching score vector comprising a set of components storing a set of match scores for a set of extracted features derived from the first plurality of field values and the second plurality of field values;
based on a plurality of matching score vectors for the plurality of training instances in the training dataset and a match objective function, determining a set of match score thresholds for the set of extracted features;
generating a set of match rules, each match rule in the set of match rules comprising a set of predicates based at least in part on a set of predicate features selected from the set of extracted features, each predicate in the set of predicates making a predication on whether two records match by comparing a match score derived from the two records against a match score threshold;
applying the set of matching rules to two or more records each having a plurality of field values for the plurality of fields to determine whether there is a match between any two of the two or more records.

9. The media as recited in claim 8, wherein each match score thresholds in the set of match score thresholds is used for comparison with match scores of a respective feature in the set of extracted features, as computed from records having field values of the plurality of fields, to make match or non-match predictions with respect to the records; wherein each such match score thresholds in the set of match score thresholds is obtained from a plurality of match scores of the respective feature, as computed from training records in a plurality of instances, by minimizing a match error based on the match objective function.

10. The media as recited in claim 8, wherein the set of match rules comprises a match rule that are conjunctively joined by two or more predicates; wherein the two or more predicates comprises a first predicate generated based on a first feature that is identified by a machine learning process as the most discriminating feature in the set of extracted features; wherein the two or more predicates comprises a second predicate generated based on a second feature that is identified as having the least mutual information with the first feature.

11. The media as recited in claim 8, wherein the two or more records belong to a set of database records among a plurality of sets of database records stored in a cloud-based computing system; wherein each set of database records represent a respective type of entity among a plurality of different types of entities; wherein the plurality of different types of entities includes at least one of: accounts, contacts, leads, company locations, company entities, products, shipping addresses, time events, or calendar entries.

12. The media as recited in claim 8, wherein the set of match rules are initially generated fully automatically by a machine learning process from the plurality of training instances in the training dataset.

13. The media as recited in claim 8, wherein the set of match rules comprises a match rule that is displayed to a user through a user interface and that is edited by the user through the user interface; wherein an editing operation performed based on user input includes one of: modifying predicate composition of the match rule, modifying a match score threshold in a predicate in the match rule, modifying a feature extraction method for extracting a feature in a predicate in the match rule, or modifying a similarity function used to determine match scores for a feature in a predicate in the match rule.

14. The media as recited in claim 8, wherein the set of match rules are among a plurality of sets of match rules generated at least in part by supervised machine learning implemented by one or more computing devices; wherein the plurality of sets of match rules is applied by a computing system to provide at least one of: (a) automatic entity matching and recognition among a massive volume of data in the computing system, (b) data consistency across over a set of database tables across a plurality of instances of one or more datacenters in the computing system, or (c) complete white-box information about a match or non-match decision made with any match rule in the plurality of sets of match rules in terms of specific predicates used in the match rule, specific feature extraction methods used in the specific predicates of the match rule, specific similarity measure used to compute match scores for the specific predicates of the match rule, or specific match score threshold used to compare computed match scores for the specific predicates of the match rule.

15. A system, comprising:
one or more computing processors;
one or more non-transitory computer readable media storing a program of instructions that is executable by the one or more computing processors to perform:
receiving a training dataset having a plurality of training instances, each training instance in the plurality of training instances comprising (a) a pair of training records with a first record and a second record and (b) a label indicates whether there is a match between the first record and the second record, the first record having a first plurality of field values for a plurality of fields, the second record having a second plurality of field values for the plurality of field;
determining a matching score vector for each such training instance, the matching score vector comprising a set of components storing a set of match scores for a set of extracted features derived from the first plurality of field values and the second plurality of field values;
based on a plurality of matching score vectors for the plurality of training instances in the training dataset and a match objective function, determining a set of match score thresholds for the set of extracted features;
generating a set of match rules, each match rule in the set of match rules comprising a set of predicates based at least in part on a set of predicate features selected from the set of extracted features, each predicate in the set of predicates making a predication on whether two records match by comparing a match score derived from the two records against a match score threshold;
applying the set of matching rules to two or more records each having a plurality of field values for the plurality of fields to determine whether there is a match between any two of the two or more records.

16. The system as recited in claim 15, wherein each match score thresholds in the set of match score thresholds is used for comparison with match scores of a respective feature in the set of extracted features, as computed from records having field values of the plurality of fields, to make match or non-match predictions with respect to the records; wherein each such match score thresholds in the set of match score thresholds is obtained from a plurality of match scores of the respective feature, as computed from training records in a plurality of instances, by minimizing a match error based on the match objective function.

17. The system as recited in claim 15, wherein the set of match rules comprises a match rule that are conjunctively joined by two or more predicates; wherein the two or more predicates comprises a first predicate generated based on a first feature that is identified by a machine learning process as the most discriminating feature in the set of extracted features; wherein the two or more predicates comprises a second predicate generated based on a second feature that is identified as having the least mutual information with the first feature.

18. The system as recited in claim 15, wherein the two or more records belong to a set of database records among a plurality of sets of database records stored in a cloud-based computing system; wherein each set of database records represent a respective type of entity among a plurality of different types of entities; wherein the plurality of different types of entities includes at least one of: accounts, contacts, leads, company locations, company entities, products, shipping addresses, time events, or calendar entries.

19. The system as recited in claim 15, wherein the set of match rules are initially generated fully automatically by a machine learning process from the plurality of training instances in the training dataset.

20. The system as recited in claim 15, wherein the set of match rules comprises a match rule that is displayed to a user through a user interface and that is edited by the user through the user interface; wherein an editing operation performed based on user input includes one of: modifying predicate composition of the match rule, modifying a match score threshold in a predicate in the match rule, modifying a feature extraction method for extracting a feature in a predicate in the match rule, or modifying a similarity function used to determine match scores for a feature in a predicate in the match rule.

21. The system as recited in claim 15, wherein the set of match rules are among a plurality of sets of match rules generated at least in part by supervised machine learning implemented by one or more computing devices; wherein the plurality of sets of match rules is applied by a computing system to provide at least one of: (a) automatic entity matching and recognition among a massive volume of data in the computing system, (b) data consistency across over a set of database tables across a plurality of instances of one or more datacenters in the computing system, or (c) complete white-box information about a match or non-match decision made with any match rule in the plurality of sets of match rules in terms of specific predicates used in the match rule, specific feature extraction methods used in the specific predicates of the match rule, specific similarity measure used to compute match scores for the specific predicates of the match rule, or specific match score threshold used to compare computed match scores for the specific predicates of the match rule.
